(19) United States
(12) Patent Application Publication
(10) Pub. No.: US 2017/0220762 A1
(43) Pub. Date: Aug. 3, 2017

(54) SYSTEM, METHOD, AND NON-TRANSITORY COMPUTER-READABLE STORAGE MEDIA FOR GENERATING DATA FOR USE IN COMPUTER SYSTEMS

(71) Applicant: Wal-Mart Stores, Inc., Bentonville, AR (US)

(72) Inventors: Justin Toupin, San Francisco, CA (US); Nathan Thomas Diepenbrock, Highlands Ranch, CO (US)

(21) Appl. No.: 15/009,454

(22) Filed: Jan. 28, 2016

(51) Int. Cl. G06F 19/00; H04L 29/06

(52) U.S. Cl. CPC G06F 19/3456; G06F 19/322; H04L 63/102; H04L 63/0861

(57) ABSTRACT

A networked computer system for generating pharmaceutical data for use in displaying pharmacy customer account records via mobile computing devices in compliance with HIPPA regulations is described herein. The networked computer system includes a server computer including a processor coupled to a memory device, and a database. The database includes user pharmacy account records including corresponding primary IDs and corresponding secondary IDs. The server computer is programmed to receive a request to access a user pharmacy account record from a user via a mobile computing device including a primary, select a user pharmacy account record associated with the received primary ID, receives a response signal including a received secondary ID being provided by the user, and initiates a pharmacy application program being stored on the mobile computing device to allow the user to access the selected user pharmacy account record if the received secondary ID matches the corresponding secondary ID.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE DISCLOSURE

U.S. Patent Classification Primary Class: 707 (DATA PROCESSING: DATABASE, DATA MINING, AND FILE MANAGEMENT OR DATA STRUCTURES). Art Unit: 2161.

The present invention relates to providing product information to a consumer, and more particularly, to systems, methods, and computer-readable storage media that monitor activities of pharmacy customers, generates data associated with the monitored activities, and generates pharmacy data records including biometric data associated with pharmacy customers for use in authenticating mobile computing devices being used by pharmacy customers.

### BACKGROUND

Many pharmacy consumers desire to obtain services related to their general heath and the pharmaceutical medications being prescribed to them remotely, e.g., on-line, through the Internet, or using a specially designed application or app on a personal computer or mobile device, such as a tablet or cell phone. In addition, pharmacy customers desire to have services that facilitate their adherence to medication schedules and improve general health monitoring.

At least some known computer systems require users to provide several forms of identification before allowing the user to access pharmacy records being stored on these systems. Moreover, many pharmacy consumers have difficulty providing all of the information necessary to access pharmacy records in compliance with the Health Insurance Portability and Accountability Act (HIPPA). Furthermore, because of the increasing number of pharmaceutical drugs being made available to consumers and the amount of drug information associated with the pharmaceutical drugs, users may become frustrated with the amount of information that must be manually entered into these known systems to allow the customer access to their records. Moreover, as the amount of records being included in a database increases, the amount of computing resources that are required to maintain these records and perform related services increase, thus reducing the overall performance of these systems. In addition, because these known systems also require the user to periodically update the information, over time the information related to the user becomes outdated and irrelevant, thus reducing the overall benefit of services being provided to the user.

The present invention is aimed at one or more of the problems identified above.

### SUMMARY OF THE INVENTION

In different embodiments of the present invention, systems, methods, and computer-readable storage media for generating and displaying information to users via mobile computing devices.

In one embodiment of the present invention, a networked computer system for generating pharmaceutical data for use in displaying pharmacy customer account records via mobile computing devices in compliance with HIPPA regulations is provided. The networked computer system includes a server computer including a processor coupled to a memory device, and a database. The database includes a list of user pharmacy account records associated with pharmacy customers. Each user pharmacy account record includes customer identification information associated with a pharmacy customer and pharmaceutical drug information associated with corresponding prescription drug medications. The customer identification information includes a corresponding primary ID and a corresponding secondary ID. The server computer is programmed to receive a request to access a user pharmacy account record from a user via a mobile computing device including a primary ID provided by the user, access the list of user pharmacy account records, select a user pharmacy account record associated with the received primary ID. The server computer transmits a verification request signal to the mobile computing device to cause the mobile computing device to display a request to the user to provide a secondary ID, receives a response signal including a received secondary ID being provided by the user, and determines if the received secondary ID matches the corresponding secondary ID included in the selected user pharmacy account record. The server computer then initiates a pharmacy application program being stored on the mobile computing device to allow the user to access the selected user pharmacy account record via the mobile computing device if the received secondary ID matches the corresponding secondary ID included in the selected user pharmacy account record.

In another embodiment of the present invention, a computer-implemented method of operating a networked computer system for generating pharmaceutical data for use in displaying pharmacy customer account records via mobile computing devices in compliance with HIPPA regulations is provided. The networked computer system includes a database and a server computer including a processor coupled to a memory device. The method includes the steps of the server computer receiving a request to access a user pharmacy account record from a user via a mobile computing device including a primary ID provided by the user and accessing a database including a list of user pharmacy account records associated with pharmacy customers. Each user pharmacy account record includes customer identification information associated with a pharmacy customer and pharmaceutical drug information associated with corresponding prescription drug medications. The customer identification information includes a corresponding primary ID and a corresponding secondary ID. The server computer selects a user pharmacy account record associated with the received primary ID and transmits a verification request signal to the mobile computing device to cause the mobile computing device to display a request to the user to provide a secondary ID. The server computer receives a response signal including a received secondary ID being provided by the user and determines if the received secondary ID matches the corresponding secondary ID included in the selected user pharmacy account record. The server computer then initiates a pharmacy application program being stored on the mobile computing device to allow the user to access the selected user pharmacy account record via the mobile computing device if the received secondary ID matches the corresponding secondary ID included in the selected user pharmacy account record.

In yet another embodiment, one or more non-transitory computer-readable storage media, having computer-executable instructions embodied thereon are provided. When executed by at least one processor, the computer-executable instructions cause the processor to receive a request to access a user pharmacy account record from a user via a mobile computing device including a primary ID provided by the user, and access a database including a list of user pharmacy account records associated with pharmacy customers. Each user pharmacy account record includes customer identification information associated with a pharmacy customer and pharmaceutical drug information associated with corresponding prescription drug medications. The customer identification information includes a corresponding primary ID and a corresponding secondary ID. The processor selects a user pharmacy account record associated with the received primary ID, transmits a verification request signal to the mobile computing device to cause the mobile computing device to display a request to the user to provide a secondary ID, receives a response signal including a received secondary ID being provided by the user, and determines if the received secondary ID matches the corresponding secondary ID included in the selected user pharmacy account record. The processor then initiates a pharmacy application program being stored on the mobile computing device to allow the user to access the selected user pharmacy account record via the mobile computing device if the received secondary ID matches the corresponding secondary ID included in the selected user pharmacy account record.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present invention;

FIG. 2 is a schematic illustrating example components of a point-of-sale (POS) terminal system that may be used with the system shown in FIG. 1, according to an embodiment of the present invention;

FIG. 3 is a schematic illustrating example components of a server computer that may be used with the system shown in FIG. 1, according to an embodiment of the present invention;

FIGS. 4-5 are flowcharts of methods that may be used with the system shown in FIG. 1, according to embodiments of the present invention;

FIG. 6 is an illustration of exemplary database records generated by the system of FIG. 1, according to embodiments of the present invention; and

FIGS. 7-11 are illustrations of exemplary screenshots from the system of FIG. 1, according to an embodiment of the present invention.

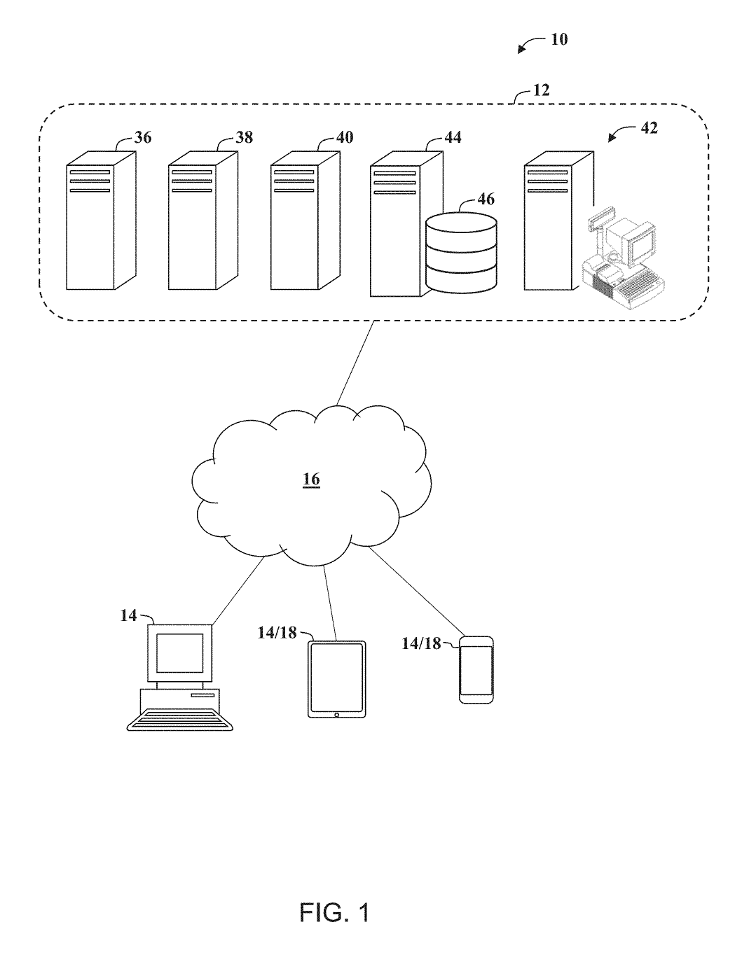

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

With reference to the FIGS. and in operation, the present invention provides a networked computer system 10, methods and computer product media that includes a pharmacy server system that generates and stores pharmacy customer account records that include customer information that may be displayed on a mobile device to allows the customer to access, view, and/or modify the data included in the pharmacy customer account, and to interact with and operate the system to receive additional services provided by a retail pharmacy. For example, the system may install a mobile computer program application on the mobile device that allows the pharmacy customer to access services being provided by the retail pharmacy such as, for example, ordering prescription pharmaceutical medications, order prescription medication refills, viewing refill status, obtaining drug information associated with the prescription pharmaceutical medications, making payments, scheduling pharmacists consultations, and the like.

In addition the system generates pharmacy customer account records including unique customer identification information to enable the system to limit access to the pharmacy customer account records in compliance with HIPPA regulations. In the illustrated embodiment, the system generates pharmacy customer account records including primary identification data and secondary identification data. The primary identification data may include a username and/or password. The secondary identification data includes biometric data provided by the pharmacy customer including, for example, a fingerprint, a voiceprint, and/or a facial image of the customer. The primary and the secondary identification data may be used to verify an identity of a user of a mobile device before providing pharmacy customer account information on the mobile device. For example, the system may receive a request to access a pharmacy customer account from a mobile device. The system requests and receives primary identification data from the user via the mobile device and selects a corresponding pharmacy customer account record. The system may also request biometric data from the user, and receive the user's biometric data from the mobile device. The system determines if the received biometric data matches the secondary identification data included in the pharmacy customer account record and allows the user to access the selected pharmacy customer account record upon verifying matching biometric data. In addition, the system provides a unique form of secondary authentication/identity validation based on smartphone capabilities. Potential options include authentication based on: a verified device or biometric data collected by the phone (e.g., fingerprint).

By generating pharmacy customer account records that including secondary identification data associated with customer biometric data, the system improves the security, speed and functionality of known computing systems by reducing the amount of computing time required to validate the identify of a pharmacy customer and displaying data records to the pharmacy customer via mobile devices, thus reducing the computing resources required to generate and maintain pharmacy customer records.

For clarity in discussing the various functions of the system 10, multiple computers and/or servers are discussed as performing different functions. These different computers (or servers) may, however, be implemented in multiple different ways such as modules within a single computer, as nodes of a computer system, etc. . . . The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

Other features of the system 10 can be found in the following commonly owned US Patent Applications, which are hereby incorporated by reference: U.S. patent application Ser. No. ______, filed on Jan. 28, 2016 (Attorney Docket Number 068571.00242); U.S. patent application Ser. No. ______, filed on Jan. 28, 2016 (Attorney Docket Number 068571.00243); U.S. patent application Ser. No. ______, filed on Jan. 28, 2016 (Attorney Docket Number 068571.00244); U.S. patent application Ser. No. ______, filed on Jan. 28, 2016 (Attorney Docket Number 068571.00245); U.S. patent application Ser. No. ______, filed on Jan. 28, 2016 (Attorney Docket Number 068571.00246); U.S. patent application Ser. No. ______, filed on Jan. 28, 2016 (Attorney Docket Number 068571.00247); U.S. patent application Ser. No. ______, filed on Jan. 28, 2016 (Attorney Docket Number 068571.00248); U.S. patent application Ser. No. ______, filed on Jan. 28, 2016 (Attorney Docket Number 068571.00250); U.S. patent application Ser. No. ______, filed on Jan. 28, 2016 (Attorney Docket Number 068571.00251); U.S. patent application Ser. No. ______, filed on Jan. 28, 2016 (Attorney Docket Number 068571.00252); and, U.S. patent application Ser. No. ______, filed on Jan. 28, 2016 (Attorney Docket Number 068571.00253).

In the illustrated embodiment, the system 10 includes a server system 12 that is coupled in communication with one or more user computing devices 14 via a communications network 16. The communications network 16 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The user computing device 14 may include any suitable device that enables a user to access and communicate with the system 10 including sending and/or receiving information to and from the system 10 and displaying information received from the system 10 to a user. For example, in one embodiment, the user computing device 14 may include, but is not limited to, a desktop computer, a laptop or notebook computer, a tablet computer, smartphone/tablet computer hybrid, a personal data assistant, a handheld mobile device including a cellular telephone, and the like. The user computing device 14, as well as any other connected computer systems and their components included in the system 10, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

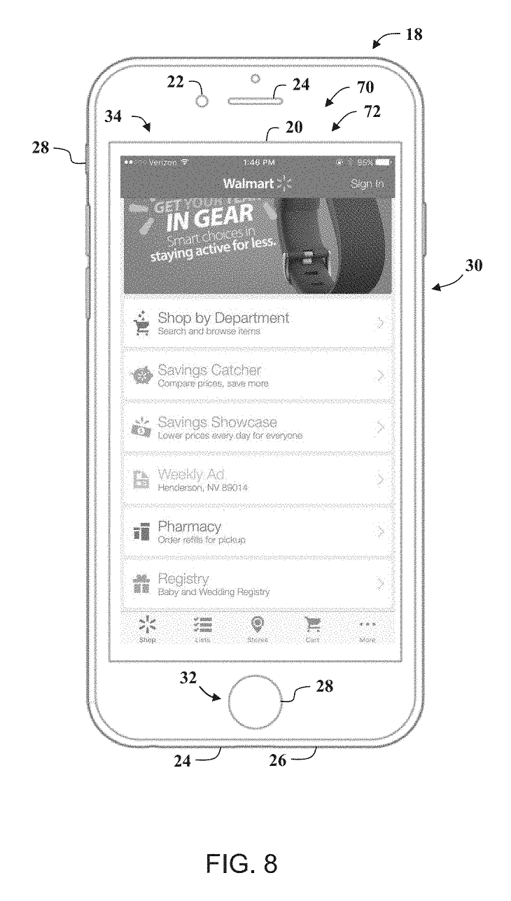

In one embodiment, the user computing device includes a mobile computing device 18 (shown in FIG. 8) such as, for example, a smartphone such as an iPhone™. The mobile computing device 18 includes a processor coupled to a memory device, and a database for storing various programs and data for use in operating the mobile computing device 18. The mobile computing device 18 may also include a touchscreen display device 20, one or more video image cameras 22, one or more speakers 24, a microphone 26, at least one input button 28, and one or more sensors 30 including, but not limited to, a touch ID fingerprint sensor 32 coupled to an input button 28, a barometer, a three-axis gyro, an accelerometer, proximity sensor, and an ambient light sensor. In addition, the mobile computing device 18 may also include a Wi-Fi antenna, a cellular network antenna, a Bluethooth™ communications device, assisted GPS and GLONASS, a digital compass, and an iBeacon microlocation device.

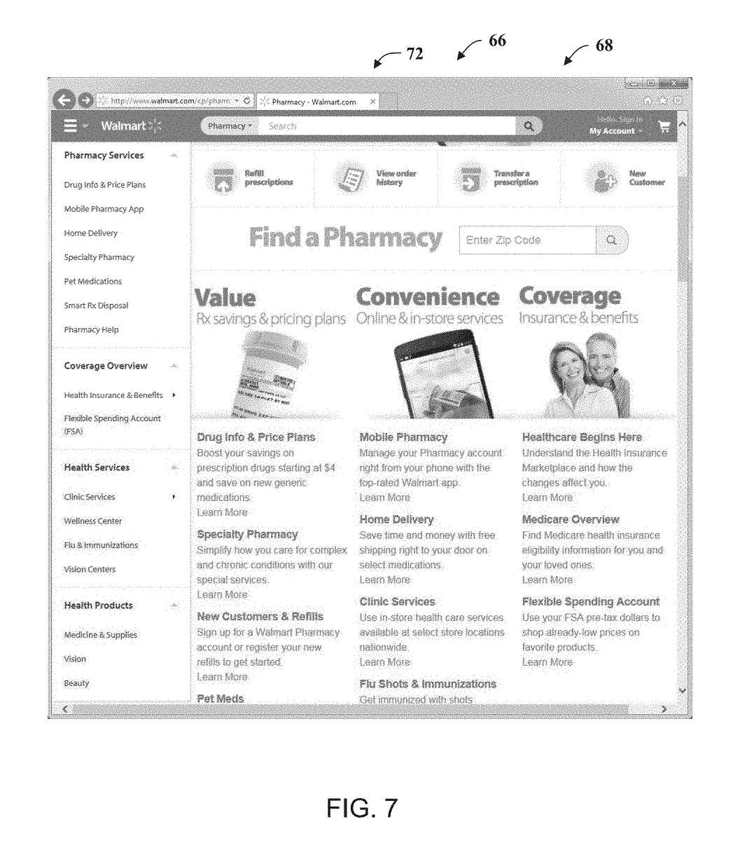

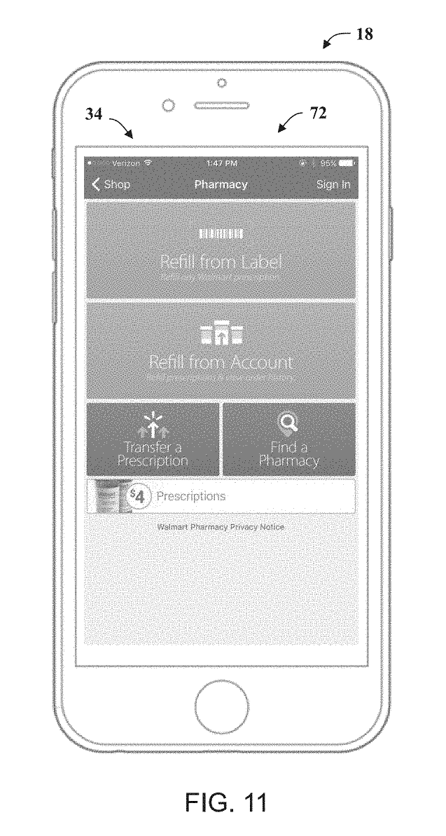

In the illustrated embodiment, the mobile computing device 18 includes a web browser program stored in the memory device. The processor executes the web browser program to display web pages on the touchscreen display device 20 that includes information received from the server system 12 to enable a user to interact with and operate the server system 12. In addition, the mobile computing device 18 may be programmed to store and execute a computer program application that displays user interfaces 34 (shown in FIGS. 7-11) on the touchscreen display device 20 that allows the user to access the server system 12 to retrieve and store information within the server system 12 as well as interact with and operate the server system 12. In addition, in one embodiment, the system 10 may install one or more mobile computer application programs in the memory device of the mobile computing device 18. When initiated by the processor of the mobile computing device 18, the mobile computer application program causes the processor of the mobile computing device 18 to perform some or all of the functions of the server system 12.

For example, in one embodiment, the server system 12 may install a pharmacy mobile computer application program on the mobile computing device 18 to allow the user to operate the mobile computing device 18 to transmit data to and receive data from the server system 12. In addition, the pharmacy mobile computer application program may allow the user to operate the mobile computing device 18 to generate biometric data associated with the pharmacy customer and transmit the biometric data to the server system 12 to enable the server system 12 to verify an identify of the pharmacy customer. For example, in one embodiment, the pharmacy mobile computer application program allows the user to operate the touch ID fingerprint sensor 32 to detect a fingerprint of the user and transmit biometric data indicating the user's fingerprint to the server system 12. In addition, the user may operate the video image cameras 22 to capture a facial image of the user and generate and transmit biometric data associated with the user's facial image. Moreover, the pharmacy mobile computer application program may allow the user to operate the mobile device microphone to record a voiceprint of the user and generate and transmit biometric data of the recorded voiceprint to the server system 12.

In the illustrated embodiment, the server system 12 includes a website hosting server 36, e-receipts server 38, a pharmacy account server 40, a point-of-sale (POS) system 42, a database server 44, and a database 46. The database server 44 includes a memory device that is connected to the database 46 to retrieve and store information contained in the database 46. The database 46 contains information on a variety of matters, such as, for example, web pages associated with one or more websites, search queries, pharmaceutical drug information, refill information, customer authentication information, customer biometric data, customer pharmacy account information, product records, notification messages, mobile device identifies, mobile device application program interfaces (APIs), and/or any suitable information that enables the system 10 to function as described herein. In one embodiment, some or all of the information contained in the database 46 may also be stored in the database of the mobile computing device 18.

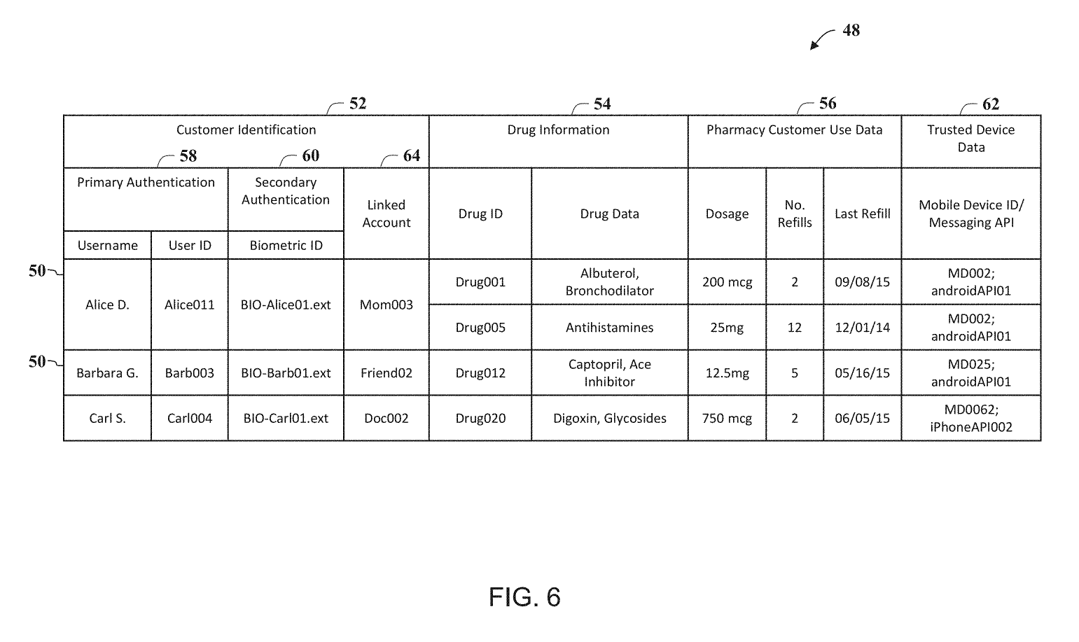

In the illustrated embodiment, the database 46 includes a pharmacy account list 48 (shown in FIG. 6) that includes a plurality of user pharmacy account records 50. Each user pharmacy account record 50 is associated with a corresponding pharmacy customer and includes customer identification data 52, pharmaceutical drug data 54 including information associated with pharmaceutical drugs prescribed to and/or purchased by the corresponding pharmacy customer, and pharmacy customer use data 56 including information associated with the pharmacy customer's use of the corresponding pharmaceutical drug.

The customer identification data 52 includes primary authentication data 58 and secondary authentication data 60. The primary authentication data 58 includes user identifying data such as, for example, a unique customer identified (ID) and/or password. The primary authentication data 58 may also include user contact information such as, for example, a phone number, an email, and/or a mobile device data 62 associated with a mobile computing device 18 associated with the corresponding pharmacy customer. For example, the mobile device data 62 may include, but is not limited to, a unique mobile device ID, operating system, phone number, IP address, mobile device API, and/or any suitable information that enables the system 10 to communicate with the corresponding mobile computing device 18.

The secondary authentication data 60 includes a biometric ID including a biometric identification file including unique biometric data associated with a corresponding pharmacy customer. The biometric ID may include biometric data in a plurality of biometric data formats such as, for example, fingerprint, a voiceprint, and/or a facial image, and/or any suitable biometric data format that may include information associated with a unique identifiable physical attribute of the pharmacy customer such as, for example, fingerprint, palm veins, face recognition, DNA, palm print, hand geometry, iris recognition, retina and odour/scent, and/or any suitable computer data that may be generated during a biometric process.

In one embodiment, the customer identification data 52 may also include a linked account information 64 associated with additional users that are associated with the corresponding pharmacy customer. The linked account information 64 may include a unique linked user ID and/or password that is associated with the additional users to allow the additional users to access some or all of the information being included in the user pharmacy account record 50. For example, the linked account information 64 may be associated with friends, relatives, and/or healthcare professionals associated with the pharmacy customer. The linked account information may also include contact information such as, for example, emails and/or text and phone numbers associated with the additional users, and/or include information associated with another user pharmacy account record.

In one embodiment, the pharmaceutical drug data 54 may include, but is not limited to, a unique drug ID associated with the pharmaceutical drug, a drug name, a pharmaceutical drug description, a drug category, and/or any suitable information associated with the corresponding pharmaceutical drug. The pharmacy customer use data 56 may include information indicating activities associated with the pharmacy customers such as, for example, dosage information, a number of refills remaining, a refill frequency, a date and/or time of the last refill purchase, purchase date, and/or prescription expiration, and/or any suitable information associated with pharmacy customer activity.

The website hosting server 36 is configured to host a website 66 that is accessible by a user via one or more user computing devices 14. The website hosting server 36 retrieves and stores webpages 68 (shown in FIG. 7) associated with one or more websites 66 in response to requests received by the user via the user computing device 14 to allow users to interact with the website and search and/or purchase products such as, for example, goods and/or services via the website. In one embodiment, the website hosting server 36 is configured to generate and display webpages 68 associated with the website in response to requests being received from consumers via corresponding web browsers that are displayed on the user computing devices 14. In addition, the website hosting server 36 may be configured to generate and display a mobile webpage 70 (shown in FIGS. 8-11) that is displayed on one or more mobile computing devices 18. For example, in one embodiment, the website hosting server 36 may display a pharmacy webpage 72 (shown in FIGS. 7-11) in response to receiving a user request that allows a user to access a corresponding user pharmacy account record 50, input product search requests including search criteria including one or more search terms, purchase pharmaceutical drugs, request prescription refills, request pharmacist consultations, schedule pharmacy and/or medical clinic appointments, and the like.

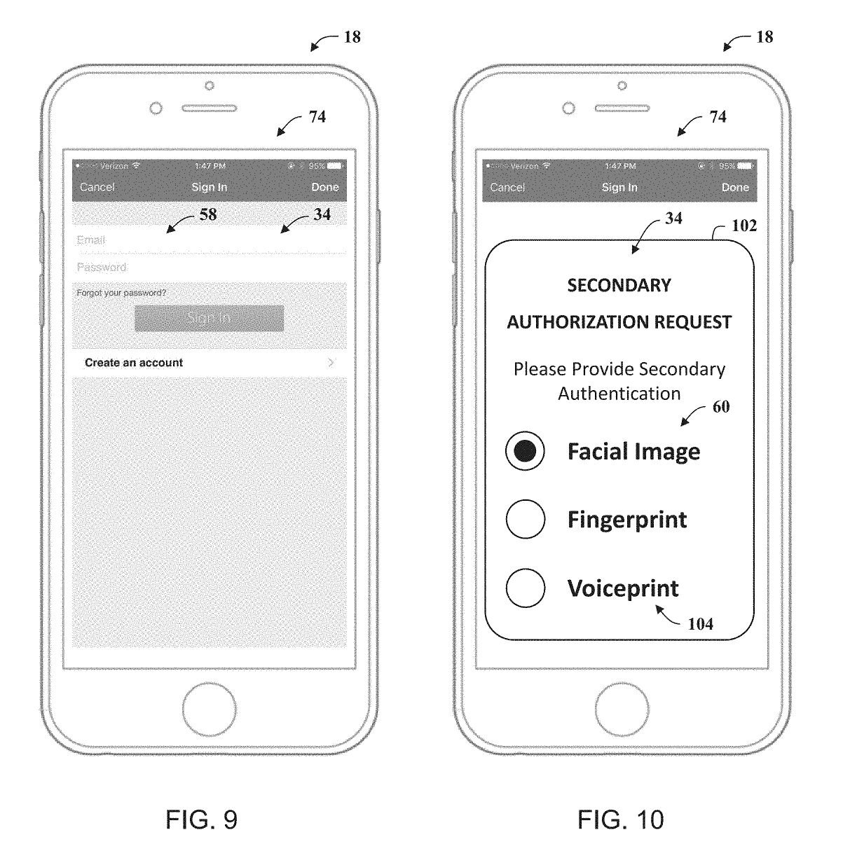

The website hosting server 36 may allow customers to login and access corresponding customer pharmacy accounts including account information such as, for example, previous purchases, pending prescription orders, pending medication refills, and/or pharmaceutical drug information. For example, the website hosting server 36 may display a login page 74 (shown in FIGS. 9-10), receive a unique customer ID such as, for example, a username and/or password, and identify the customer account associated with the unique customer ID to enable the identified customer to access information and/or features associated with the corresponding customer pharmacy account.

The e-receipts server 38 receives and stores information associated with consumer retail purchases in the database 46 and is programmed to generate and store electronic receipt data associated with the consumer retail purchases. In addition, the e-receipts server 38 may be programmed to transmit signals indicating pharmacy customer purchases to the pharmacy account server 40. In one embodiment, the e-receipts server 38 may communicate with the POS system 42 as well as other computer systems at each of one or more physical store locations (e.g., on an internal corporate network) to facilitate business operations for the corresponding entity. For example, a pharmacy customer may purchase a pharmaceutical drug using a POS system 42 at a retail pharmacy location. The e-receipts server 38 may generate e-receipt data indicating the purchase and transmit the e-receipt data to the pharmacy account server 40 for use in modifying a corresponding user pharmacy account record 50 to include information associated with the pharmaceutical drug purchase.

The e-receipts server 38 is programmed to receive application identifiers and digital receipt data, including item data for one or more purchased items, from POS systems at various different store locations, and generate and store digital receipts from received receipt data. Generating digital receipts can include item data for items included in corresponding digital receipt data (but potentially in a different format, for example, a format deliverable to mobile devices). Formulated digital receipts can also contain other data related to a transaction, such as, for example, the payment method used for the transaction, coupons, surveys, etc. Additional details of adjacent special symbol positions, which may be used in the present invention, are described in U.S. patent application Ser. No. 13/730,721 to Argue et al, filed Dec. 28, 2012, titled “Searching Digital Receipts at a Mobile Device”, the disclosure of which is incorporated herein by reference in its entirety.

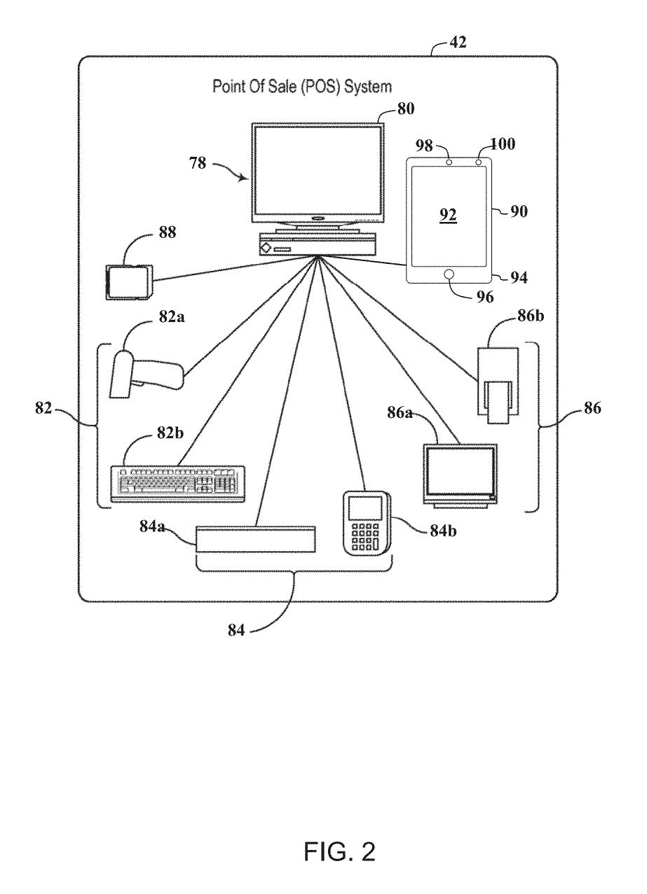

Referring to FIG. 2, the POS system 42 may include various components for use in facilitating purchases of prescription pharmaceutical drugs and generating information associated with pharmacy customers and prescription drugs being purchased by the pharmacy customers. For example, a pharmacy customer may purchase a pharmaceutical drug using a POS system 42 at a retail pharmacy location. The POS system 42 may generate and transmit data and information associated with the purchase to the e-receipts server 38 and/or the pharmacy account server 40 for use in generating and/or modifying user pharmacy account records 50.

In some embodiments, POS system 42 includes a central or primary computer 78, a monitor 80 (e.g., a cashier-facing monitor), one or more input devices 82 (e.g., scanners 82a, keyboards 82b, scales, or the like), one or more payment devices 84 (e.g., cash drawers 84a, card readers 84b) for receiving or returning payments, one or more output devices 86 (e.g., customer-facing display monitor 86a, receipt printer 86b), or the like or combinations or sub-combinations thereof, and NFC module 88, such as, for example, an NFC dongle. The POS computer 78 may form the backbone of POS system 42. Other components 82, 84, 86, 88 forming part of a POS system 42 can communicate with computer 78. Input devices 82 and certain payment devices 84 can feed data and commands to computer 78 for processing or implementation. For example, (barcode) scanner 82a can pass data communicating the identity of one or more items to be purchased, returned, or the like to a computer 78. Similarly, card reader 84b can pass payment information to computer 78. On the other hand, output devices 86 and certain payment devices 84 can follow or implement commands issued by computer 78. For example, cash drawer 84a may open in accordance with the commands of computer 78. Similarly, customer-facing display 86a and receipt printer 86b can display or output data or information as instructed by computer 78.

In the illustrated embodiment, the POS system 42 includes a biometric data capture device 90 that is configured to capture biometric data associated with a pharmacy customer, and generate and transmit biometric data to the pharmacy account server 40. The biometric data capture device 90 may include a display device 92 and speakers 94 for providing information and instructions to the pharmacy customers, and biometric capture components such as, for example, a fingerprint sensor 96, a video image camera 98, a microphone 100, and/or any suitable device for capturing biometric data associated with a pharmacy customer. For example, the biometric data capture device 90 may be programmed to detect and capture data indicating a fingerprint of the pharmacy customer via the fingerprint sensor 96, to operate the video image camera 98 to capture images of the pharmacy customer, and/or operate the microphone 100 to capture and record a voiceprint of the pharmacy customer.

The pharmacy account server 40 is programmed to monitor activities of pharmacy customers including the purchase and use of prescription pharmaceutical medications to generate and store pharmacy records associated with the pharmacy customer activities. For example, in one embodiment, the pharmacy account server 40 may communicate with the POS system 42 to receive information associated with pharmacy customer retail purchases for use in generating and/or modifying corresponding user pharmacy account records. In addition, the POS system 42 may capture and transmit biometric data to the pharmacy account server 40 for use in generating secondary authentication data 60 associated with the corresponding user pharmacy account record 50. In addition, the pharmacy account server 40 is programmed to receive requests to access user pharmacy account records from mobile computing devices 18 associated with pharmacy customers. The pharmacy account server 40 may also be programmed to request and receive biometric data associated with users from the corresponding mobile computing devices 18.

In one embodiment, the pharmacy account server 40 may receive a purchase signal indicating a purchase of a pharmaceutical drug by a pharmacy customer from the POS system 42 and transmit a request for customer identification data 52 to the POS system 42. For example, upon receiving an indication of a purchase being made by a pharmacy customer, the pharmacy account server 40 may transmit a request to receive primary authentication data 58 including a unique username and password associated with the pharmacy customer. Upon receiving the request for primary authentication data 58, the POS system 42 may request and receive a unique username and password from the customer and transmit the received username and password to the pharmacy account server 40. The pharmacy account server 40 may then generate a corresponding user pharmacy account record 50 including the primary authentication data 58 including the received unique username and password.

In one embodiment, the system 10 may be programmed to require the pharmacy customer to establish the primary authentication data 58 using the POS system 42 located at a retail pharmacy. In another embodiment, the server system 12 may be programmed to allow the customer to establish primary authentication data 58 using the pharmacy webpage 72 displayed on a user computing device 14.

In addition, upon receiving the purchase signal from the POS system 42, the pharmacy account server 40 may transmit a request for secondary authentication data 60 including biometric data associated with the pharmacy customer to the POS system 42.

Upon receiving the request for secondary authentication data 60, the POS system 42 may request the pharmacy customer to operate the biometric data capture device 90 to provide biometric data to the POS system 42. Upon receiving the biometric data from the biometric data capture device 90, the POS system 42 transmits the captured biometric data to the pharmacy account server 40 for use in generating the secondary authentication data 60. The pharmacy account server 40 receives the biometric data associated with the pharmacy customer and generates the secondary ID associated with the pharmacy customer, and generates a user pharmacy account record 50 including the generated primary ID and the generated secondary ID.

In the illustrated embodiment, the pharmacy account server 40 is programmed to receive a request to access a user pharmacy account record from a user via a mobile computing device 18 including a primary ID provided by the user. For example, in one embodiment, the pharmacy account server 40 may receive a request from a pharmacy mobile computer application program being executed by a mobile computing device 18 and cause the mobile computing device 18 to display a mobile login screen 74 (shown in FIGS. 9-10) and require the user to enter the primary ID including a username and password. Upon entering the primary ID, the user operates the mobile computing device 18 to transmit the primary ID to the pharmacy account server 40.

Upon receiving the primary ID from the mobile computing device 18, the pharmacy account server 40 accesses the pharmacy account list 48 and selects a user pharmacy account record 50 that is associated with the primary ID. For example, in one embodiment, the pharmacy account server 40 accesses the primary authentication data 58 included in the user pharmacy account records 50 and selects a user pharmacy account record 50 having a matching primary ID included in the primary authentication data 58. Upon selecting the user pharmacy account record 50, the pharmacy account server 40 transmits a verification request signal to the mobile computing device to cause the mobile computing device 18 to display a verification request 102 (shown in FIG. 10) to the user to provide a secondary ID. The user may then operate the mobile computing device 18 to capture biometric data associated with the user and generate and transmit a secondary ID including the captured biometric data to the pharmacy account server 40. For example, the pharmacy account server 40 may transmit the verification request signal to initiate the pharmacy mobile computer application program being stored on the mobile computing device 18 to operate the mobile computing device 18 to receive biometric data from the user via the mobile computing device 18.

In one embodiment, the pharmacy account server 40 may operate the pharmacy mobile computer application program to cause the mobile computing device 18 to display the verification request 102 including a plurality of secondary ID selections 104 that are selectable by the user. Each secondary ID selection 104 may corresponding to a biometric data format associated with the selected user pharmacy account record such as, for example, a fingerprint, a voiceprint, and/or a facial image. The pharmacy mobile computer application program allows the user to select one or more of the displayed secondary ID selections 104 and operates the mobile computing device 18 to capture biometric data including the biometric data format associated with the user selected secondary ID selection 104.

In one embodiment, the pharmacy account server 40 may determine a biometric data format associated with the corresponding secondary ID included in the selected user pharmacy account record 50 and determine if the mobile computing device 18 is capable of receiving the biometric data format associated with the selected user pharmacy account record 50. The pharmacy account server 40 may then display the verification request 102 including only those secondary ID selections 104 having corresponding biometric data formats that are compatible with the corresponding mobile computing device 18. If the mobile computing device 18 does not support any of the biometric data formats included in the selected user pharmacy account records, the pharmacy account server 40 may display a notification message on the mobile computing device 18 to inform the user that the device does not support mobile access to the selected user pharmacy account record 50.

In the illustrated embodiment, the pharmacy account server 40 is programmed to receive a response signal from the mobile computing device 18 including the secondary ID including the biometric data being provided by the user, and determine if the received secondary ID matches the corresponding secondary ID included in the selected user pharmacy account record 50. For example, the pharmacy account server 40 may access the secondary authentication data 60 included in the selected user pharmacy account record 50 and determine if the received secondary ID matches data included in the secondary authentication data 60. Upon determining that the received secondary ID matches the corresponding secondary ID included in the selected user pharmacy account record 50, the pharmacy account server 40 initiates the pharmacy mobile computer application program to display the information associated with the selected user pharmacy account record 50 and to display a user interface 34 that allows the user to access the selected user pharmacy account record 50 via the mobile computing device 18.

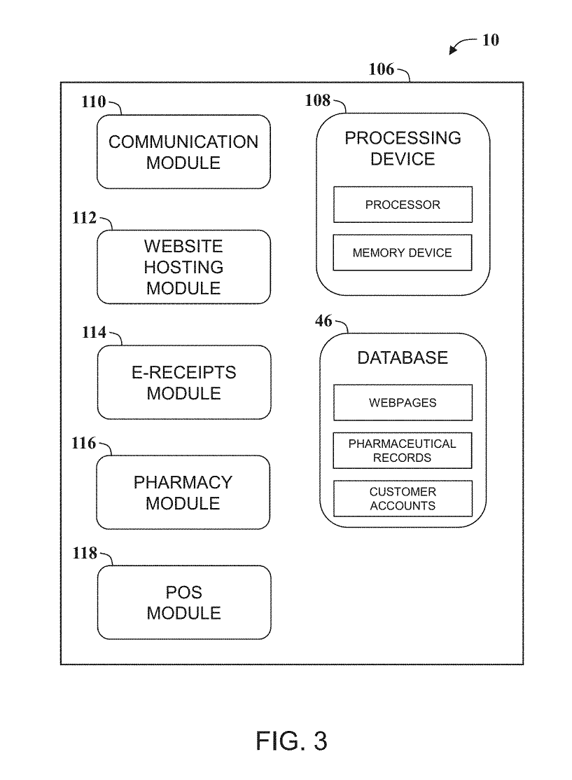

Referring to FIG. 3, in one embodiment, the system 10 may include a system server computer 106 that is configured to perform the functions of the website hosting server 36, the e-receipts server 38, the pharmacy account server 40, the POS system 42, and the database server 44. In the illustrated embodiment, the system server 106 includes a processing device 108 and the database 46.

The processing device 108 executes various programs, and thereby controls components of the system server 106 according to user instructions received from the user computing device 14. The processing device 108 may include memory, e.g., read only memory (ROM) and random access memory (RAM), storing processor-executable instructions and one or more processors that execute the processor-executable instructions. In embodiments where the processing device 108 includes two or more processors, the processors can operate in a parallel or distributed manner. In an example, the processing device 108 may execute a communications module 110, a website hosting module 112, an e-receipts module 114, a pharmacy account module 116, and a POS module 118.

The processing device 108 may also include a memory device for storing programs and information in the database 46, and retrieving information from the database 46 that is used by the processor to perform various functions described herein. The memory device may include, but is not limited to, a hard disc drive, an optical disc drive, and/or a flash memory drive. Further, the memory device may be distributed and located at multiple locations.

The communications module 110 retrieves various data and information from the database 46 and sends information to the user computing device 14 via the communications network 16 to enable the user to access and interact with the system 10. In one embodiment, the communications module 110 displays various images on a graphical interface of the user computing device 14 preferably by using computer graphics and image data stored in the database 46 including, but not limited to, web pages, pharmacy records, pharmacy notification messages, product lists, and/or any suitable information and/or images that enable the system 10 to function as described herein.

The website hosting module 112 may be programmed to perform some or all of the functions of the website hosting server 36 including hosting various web pages associated with one or more websites that are stored in the database 46 and that are accessible to the user via the user computing device 14. The website hosting module 112 may be programmed to generate and display web pages associated with a website in response to requests being received from users via corresponding web browsers.

The e-receipts module 114 may be programmed to perform some or all of the functions of the e-receipts server 38 including generating, receiving, and storing e-receipt data in the database 46 and detecting purchases being made by the pharmacy customers.

The pharmacy account module 116 may be programmed to perform some or all of the functions of the pharmacy account server 40 including monitoring activities associated with pharmacy customers including consumer purchase and/or prescription refill requests. The pharmacy account module 116 may also be programmed to generate pharmacy customer account records including biometric data associated with the pharmacy customer and use the biometric data to validate mobile computing devices 18 requesting access to the pharmacy customer account records.

The POS module 118 may be programmed to perform some or all of the functions of the POS system 42 including facilitating pharmacy customer purchases and capturing biometric data using the biometric data capture device 90.

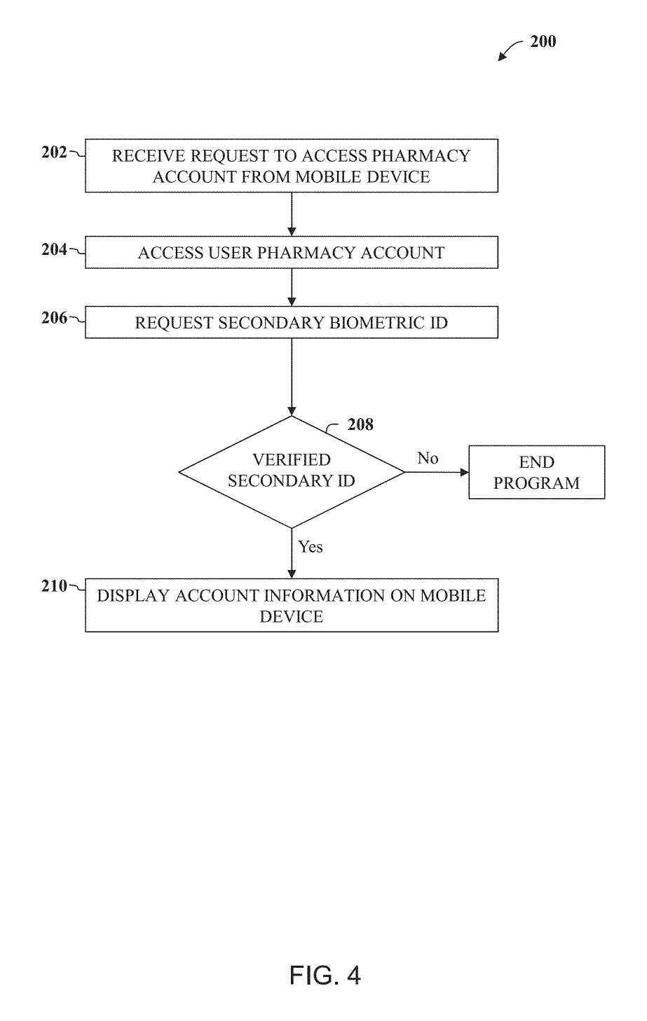

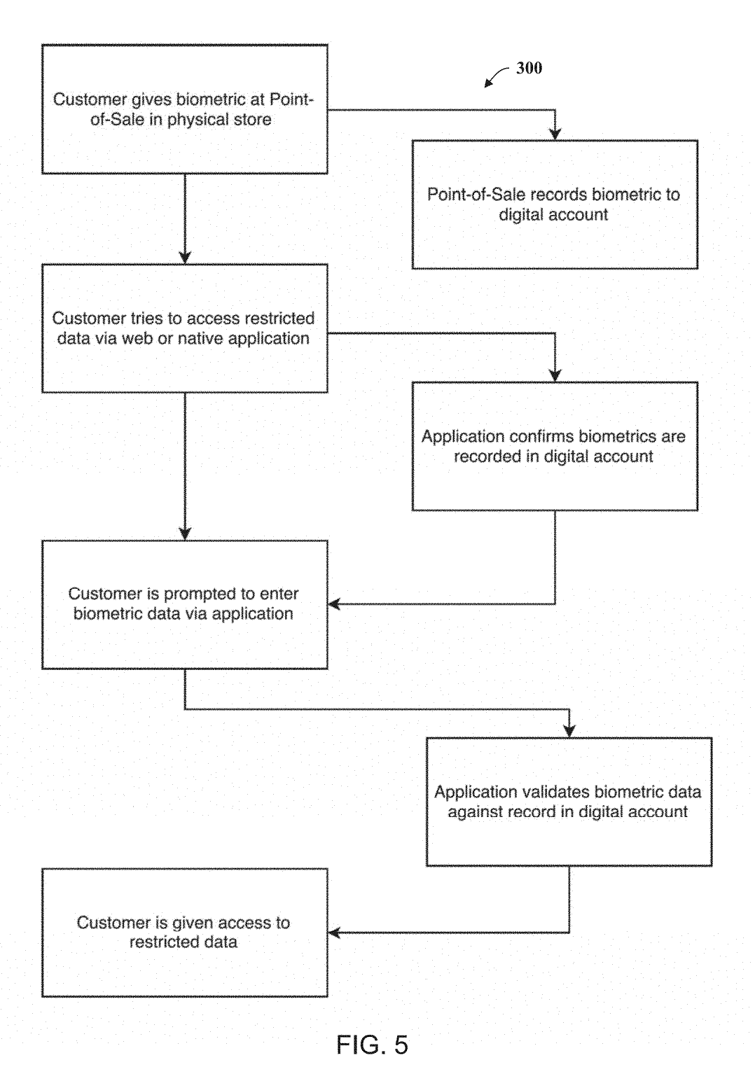

FIGS. 4-5 are flowcharts of methods 200 and 300 that may be used with the system 10 for monitoring activities of pharmacy customers and generating pharmaceutical data. The methods include a plurality of steps. Each method step may be performed independently of, or in combination with, other method steps. Portions of the methods may be performed by any one of, or any combination of, the components of the system 10. FIGS. 7-11 are exemplary graphical displays that may be displayed by the system 10.

In the illustrated embodiment, the server system 12 installs a pharmacy mobile computer application program on the mobile computing device 18 to allow the user to operate the mobile computing device 18 to transmit data to and receive data from the server system 12. The pharmacy mobile computer application program allows the pharmacy customer to access services being provided by the retail pharmacy via the mobile computing device 18 including, but not limited to, ordering prescription pharmaceutical medications, order prescription medication refills, viewing refill status, obtaining drug information associated with the prescription pharmaceutical medications, making payments, scheduling pharmacists consultations, and the like.

In method step 202, server system 12 receives a request from a user to access a user pharmacy account record 50 from a mobile computing device 18, and initiates the pharmacy mobile computer application program to accesses a mobile login webpage 74 and request the user to enter a primary ID including a unique username and password. Upon entering the primary ID, the user operates the mobile computing device 18 to transmit the primary ID to the pharmacy account server 40.

In method step 204, upon receiving the primary ID from the mobile computing device 18, the pharmacy account server 40 accesses the pharmacy account list 48 and selects a user pharmacy account record 50 that is associated with the primary ID, and identifies the corresponding secondary ID associated with the selected user pharmacy account record 50.

In method step 206, the pharmacy account server 40 transmits a verification request signal to the mobile computing device 18 to cause the mobile computing device 18 to display a verification request 102 to the user to provide a secondary ID. The user may then operate the mobile computing device 18 to capture biometric data associated with the user and generate and transmit a secondary ID including the captured biometric data to the pharmacy account server 40.

In method step 208, the pharmacy account server 40 receives a response signal from the mobile computing device 18 including the secondary ID including the biometric data being provided by the user and verifies the received secondary ID by determining if the received secondary ID matches the corresponding secondary ID included in the selected user pharmacy account record 50. If the received secondary ID is not included in the secondary authentication data 60 included in the selected user pharmacy account record 50, the pharmacy account server 40 ends the program may display a notification message on the mobile computing device 18 to inform the user that the received biometric data does not match the data included in the secondary authentication data 60 and may request additional biometric data from the user.

If the received secondary ID matches the data included in the selected user pharmacy account record 50, the pharmacy server initiates method step 210 and initiates the pharmacy mobile computer application program to display the information associated with the selected user pharmacy account record 50 and to display a user interface 34 that allows the user to access the selected user pharmacy account record 50 via the mobile computing device 18.

Referring to FIG. 5, in one embodiment, the server system 12 may implement method 300. In method 300, the customer requests a purchase of a prescription pharmaceutical medication via the POS system 42 and provides biometric data to the biometric data capture device 90 associated with the POS system 42. The POS system 42 transmits the captured biometric data to the account server 40, which records the captured biometric data in a corresponding user pharmacy account record associated with the pharmacy customer. The pharmacy customer may then request to access restricted pharmacy data included in the user pharmacy account record via the pharmacy webpage 72 and/or a mobile computer application stored on a mobile computing device. Upon receiving the request to access restricted pharmacy data, the server system 12 confirms that biometric data is recorded in the digital user pharmacy account and prompts the customer to enter biometric data via the user computing device and/or the mobile computing device. The system server 106 receives the biometric data from the customer and validates the received biometric data against the recorded biometric data included in the digital user pharmacy account. Upon validating the received biometric data, the server system 12 provides the pharmacy customer with access to the restricted pharmacy data.

In general, the system 10 is configured to monitor activities of pharmacy customers and generate pharmacy user account records including information associated with pharmaceutical medications being used by pharmacy customers. In addition, the system 10 is configured to generate pharmacy customer account records including customer biometric data to enable the system to limit access to the pharmacy customer account records in compliance with HIPPA regulations. For example, the system may receive a request to access restricted pharmacy data from a mobile device, request biometric data from the user, and validate the user's biometric data against previously obtained biometric data that is associated with the restricted pharmacy data before provide access to the restricted pharmacy data. By generating pharmacy customer account records that include customer biometric data, the system improves the security, speed and functionality of known computing systems by reducing the amount of computing time required to validate the identify of a pharmacy customer and displaying data records to the pharmacy customer via mobile devices, thus reducing the computing resources required to generate and maintain pharmacy customer records.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A system, comprising:
a database including a list of user pharmacy account records associated with pharmacy customers, each user pharmacy account record including customer identification information associated with a pharmacy customer and pharmaceutical drug information associated with corresponding prescription drug medications, the customer identification information including a corresponding primary ID and a corresponding secondary ID; and
a server computer including a processor coupled to a memory device, the processor programmed to:
receive a request to access a user pharmacy account record from a user via a mobile computing device, the request including a primary ID provided by the user;
access the list of user pharmacy account records and select a user pharmacy account record associated with the received primary ID;
transmit a verification request signal to the mobile computing device to cause the mobile computing device to display a request to the user to provide a secondary ID;
receive, from the mobile computing device, a response signal including a received secondary ID being provided by the user;
determine if the received secondary ID matches the corresponding secondary ID included in the selected user pharmacy account record; and
initiate a pharmacy application program being stored on the mobile computing device to allow the user to access the selected user pharmacy account record via the mobile computing device if the received secondary ID matches the corresponding secondary ID included in the selected user pharmacy account record.

2. A system in accordance with claim 1, wherein the received secondary ID includes biometric data associated with the user.

3. A system in accordance with claim 2, wherein the biometric data is associated with at least one of a fingerprint, a voiceprint, and a facial image.

4. A system in accordance with claim 1, wherein the server computer is programmed to transmit the verification request signal to initiate the pharmacy application program being stored on the mobile computing device to operate the mobile computing device to receive biometric data from the user via the mobile computing device.

5. A system in accordance with claim 4, wherein the server computer is programmed to:
determine a biometric data format associated with the corresponding secondary ID included in the selected user pharmacy account record;
determine if the mobile computing device is capable of receiving the biometric data format associated with the selected user pharmacy account record; and
display the request to provide a secondary ID if the mobile computing device is capable of receiving the biometric data format from the user.

6. A system in accordance with claim 5, wherein the server computer is programmed to initiate the pharmacy application program being stored on the mobile computing device to cause the mobile computing device to display the request to provide a secondary ID including a plurality of secondary ID selections that are selectable by the user, each secondary ID selection indicating the biometric data format associated with the selected user pharmacy account record.

7. A system in accordance with claim 1, wherein the received primary ID includes a unique username associated with a pharmacy customer.

8. A system in accordance with claim 1, wherein the server computer is programmed to:
receive a signal indicating a pharmaceutical drug being purchased by a pharmacy customer;
receive primary customer identifying information associated with the pharmacy customer and generate a primary ID associated with the pharmacy customer;
receive biometric data associated with the pharmacy customer and generate a secondary ID associated with the pharmacy customer; and
generate a user pharmacy account record including the generated primary ID and the generated secondary ID.

9. A system in accordance with claim 8, wherein the server computer is programmed to:
receive the signal indicating a pharmaceutical drug being purchased by a pharmacy customer from a point-of-sale (POS) terminal associated with a retail pharmacy;
transmit a request for customer biometric data to the POS terminal; and
receive the biometric data associated with the pharmacy customer from the POS terminal.

10. A method, comprising:
receiving a request to access a user pharmacy account record from a user via a mobile computing device, the request including a primary ID provided by the user;
accessing a database including a list of user pharmacy account records associated with pharmacy customers, each user pharmacy account record including customer identification information associated with a pharmacy customer and pharmaceutical drug information associated with corresponding prescription drug medications, the customer identification information including a corresponding primary ID and a corresponding secondary ID;
selecting a user pharmacy account record associated with the received primary ID;
transmitting a verification request signal to the mobile computing device to cause the mobile computing device to display a request to the user to provide a secondary ID;
receiving, from the mobile computing device, a response signal including a received secondary ID being provided by the user;
determining if the received secondary ID matches the corresponding secondary ID included in the selected user pharmacy account record; and
initiating a pharmacy application program being stored on the mobile computing device to allow the user to access the selected user pharmacy account record via the mobile computing device if the received secondary ID matches the corresponding secondary ID included in the selected user pharmacy account record.

11. A method in accordance with claim 10, wherein the received secondary ID includes biometric data associated with the user.

12. A method in accordance with claim 11, wherein the biometric data is associated with at least one of a fingerprint, a voiceprint, and a facial image.

13. A method in accordance with claim 10, further comprising transmitting the verification request signal to initiate the pharmacy application program being stored on the mobile computing device to operate the mobile computing device to receive biometric data from the user via the mobile computing device.

14. A method in accordance with claim 10, further comprising:
determining a biometric data format associated with the corresponding secondary ID included in the selected user pharmacy account record;
determining if the mobile computing device is capable of receiving the biometric data format associated with the selected user pharmacy account record; and
displaying the request to provide a secondary ID if the mobile computing device is capable of receiving the biometric data format from the user.

15. A method in accordance with claim 14, further comprising initiating the pharmacy application program being stored on the mobile computing device to cause the mobile computing device to display the request to provide a secondary ID including a plurality of secondary ID selections that are selectable by the user, each secondary ID selection indicating the biometric data format associated with the selected user pharmacy account record.

16. A method in accordance with claim 10, wherein the received primary ID includes a unique username associated with a pharmacy customer.

17. A method in accordance with claim 10, further comprising:
receiving a signal indicating a pharmaceutical drug being purchased by a pharmacy customer;
receiving primary customer identifying information associated with the pharmacy customer and generate a primary ID associated with the pharmacy customer;
receiving biometric data associated with the pharmacy customer and generating a secondary ID associated with the pharmacy customer; and
generating a user pharmacy account record including the generated primary ID and the generated secondary ID.

18. A method in accordance with claim 17, further comprising:
receiving the signal indicating a pharmaceutical drug being purchased by a pharmacy customer from a point-of-sale (POS) terminal associated with a retail pharmacy;
transmitting a request for customer biometric data to the POS terminal; and
receiving the biometric data associated with the pharmacy customer from the POS terminal.

19. One or more non-transitory computer-readable storage media, having computer-executable instructions embodied thereon, wherein when executed by at least one processor, the computer-executable instructions cause the processor to:
receive a request to access a user pharmacy account record from a user via a mobile computing device, the request including a primary ID provided by the user;
access a database including a list of user pharmacy account records associated with pharmacy customers, each user pharmacy account record including customer identification information associated with a pharmacy customer and pharmaceutical drug information associated with corresponding prescription drug medications, the customer identification information including a corresponding primary ID and a corresponding secondary ID;
select a user pharmacy account record associated with the received primary ID;
transmit a verification request signal to the mobile computing device to cause the mobile computing device to display a request to the user to provide a secondary ID;
receive, from the mobile computing device, a response signal including a received secondary ID being provided by the user;
determine if the received secondary ID matches the corresponding secondary ID included in the selected user pharmacy account record; and
initiate a pharmacy application program being stored on the mobile computing device to allow the user to access the selected user pharmacy account record via the mobile computing device if the received secondary ID matches the corresponding secondary ID included in the selected user pharmacy account record.

20. One or more non-transitory computer-readable storage media in accordance with claim 19, wherein the computer-executable instructions cause the processor to:
receive a signal indicating a pharmaceutical drug being purchased by a pharmacy customer from a point-of-sale (POS) terminal associated with a retail pharmacy;
transmit a request for customer biometric data to the POS terminal;
receive primary customer identifying information associated with the pharmacy customer and generate a primary ID associated with the pharmacy customer;
receive biometric data associated with the pharmacy customer from the POS terminal and generate a secondary ID associated with the pharmacy customer; and
generate a user pharmacy account record including the generated primary ID and the generated secondary ID.
